(19) United States
(12) Patent Application Publication
(10) Pub. No.: US 2024/0417538 A1
(43) Pub. Date: Dec. 19, 2024

(54) WOOD IMPREGNATION COMPOSITIONS

(71) Applicant: Michael Windsor SYMONS, Pretoria (ZA)

(72) Inventor: Michael Windsor SYMONS, Pretoria (ZA)

(21) Appl. No.: 18/701,446

(22) PCT Filed: Oct. 14, 2022
(86) PCT No.: PCT/ZA2022/050053

§ 371 Date: Apr. 15, 2024

(30) Foreign Application Priority Data
Oct. 15, 2021 (ZA) 2021/07838

(51) Int. Cl. C08K 3/38; B27K 3/08; C08K 3/22

(52) U.S. Cl. CPC C08K 3/38; B27K 3/08; C08K 3/22; C08K 2003/2227

(57) ABSTRACT

The invention provides a lignocellulosic binder system. The binder system includes an aqueous alkali metal silicate solution; a liquid phenol formaldehyde; optionally aluminium phosphate nano particle dispersion; and optionally a component which includes boron.

### TECHNICAL FIELD OF THE INVENTION

This invention relates to wood impregnation compositions, use thereof, methods of wood impregnation and products derived therefrom.

### BACKGROUND TO THE INVENTION

The main purpose of wood impregnation has been preservation against insect and microbial attack of exterior exposed wood. The most successful wood impregnation composition has been solutions based on copper, chrome and arsenic which precipitate in the wood cellulosic make up. The precipitated compounds are trapped in the cellulose structures and resist leaching. The disadvantages of these composition are the greenish colour of the impregnated wood and the release of these toxic compound when the wood is worked or broken down. Wood impregnation has also been used to change the properties of the wood to provide hardness and stability together with preservation. For example furfural alcohol compositions which has a very dark colour. Waxes which tend to leach. Methyl methacrylates, which is effective but expensive and finds limited use on thin cross sections such as veneers, because of the high cost. Creosote which is a coal tar derivative has limited penetration into the wood and has a strong odour. Acetic anhydride has been successfully used for acetylation of hydroxyl groups on the wood cellulose chains itself. Acetic anhydride is corrosive, an irritant and combustible. Phenol formaldehyde has also been used as a wood preservative but discolours the wood and leaves a residual odour. A further example of wood hardening is the reacting of an aminoplast resin by condensation of the amine or carbamide with a mono or dialdehyde at temperatures up to 100° C.

It is an object of the invention to provide a water based, cost effective and nontoxic composition and method to impregnate wood to harden, stabilise, preserve, improve water resistance, improve colour, improve machinability, and improve fire resistance. Coniferous plantation species, for example, can be successfully treated with the composition according to the invention such as Pinus Patchula and Pinus Ellioti. The composition is particularly well suited to be used to manufacture or treat processed wood products include particle board, medium and high density fiber board, orientated strand board, veneers, paper composites such as single or multi layer corrugated boards, spirally wound paper tubing, cellular assemblies of paper vertically orientated such as Dufaylite, and multi laminates of paper boarding often referred to, in the paper industry, as chipboard, weighing in the range 400 to 900 grams per square meter per sheet.

The water-based composition is cost effective, nontoxic, stable and can be stored in the storage tanks for a long time. In addition, the composition should be activated at a temperature in final drying not exceeding 125° C., to prevent damage to the wood.

### DESCRIPTION OF THE INVENTION

According to the invention, there is provided a lignocellulosic binder system, which binder system includes:
an aqueous alkali metal silicate solution;
a liquid phenol formaldehyde;
optionally aluminium phosphate nano particle dispersion; and
optionally a component which includes boron.

The alkali metal silicate may be selected from sodium silicate solution in water of silica to sodium and/or potassium silicate solution in water

The silica to sodium ratio may be in the range in the range 0.5 to 4.1 to 1 more usually 1.6 to 2.5 to 1, more preferably 2.6 to 4.1 to 1, and 20% to 60% by mass of the composition, preferably about 50%, with a silicate to potassium ratio 2.55 to 1 to 1.45 to 1 in the range 20% to 60% by mass of the composition, preferably about 50%, or a blend of sodium and potassium silicate as above in which case the optimum proportion is 3 parts sodium silicate to 1 part potassium silicate above. Sodium silicate is preferred, at up to 60% of the composition total weight. Water is added to ensure the ideal viscosity.

The SiO₂ to Na₂O ratio may be in the range 0.5 to 4.1 more usually 1.6 to 2.5, more preferably 2.6 to 4.1. An example of a suitable sodium silicate by PQ Corp is either 3379 Or 2040 with typical silica to sodium ratios in the range 3.3 to 2 to 1. An example of a suitable potassium silicate solution is K 2550 and K 1420 by PQ Corp with silicate to potassium ratio in the range 2.55 to 1 to 1.45 to 1. When blended the preferred proportions are 3 sodium to 1 potassium silicate. Additional gauging water may be added to the silicate solutions to reach a solids percentage in the range 5% to 30%. The alkali silicates have very good wetting properties and assist in the uniform penetration of the binder composition.

The silicate has a major influence on resistance to fire, the phenolic is the main binder but the combination of both optimizes final desirable properties of the wood derivatives in all cases.

The liquid phenol formaldehyde component in the form of a resole resin at up to 15% to 90%, preferably between 20 and 60%, more preferably about 50% by mass of the composition. The resin may include organic esters as catalysts at between 10% to 20% by mass of the resin. For medium speed catalysis are used glycerol di and/or tri acetate. For higher speed catalysis, propylene carbonate may be used. Alternatively, a resin that is latent or unpolymerized until subjected to a temperature of 80° C. is preferred, an example being SSA3500 by Schenectady International.

The balance between phenolic resin percentage in the impregnation composition and the sodium silicate percentage that gives the best cost to property ratio is in the range;
Phenolic resole resin 48% to 56%, most preferably 52% to 55%
Alkali silicate [PQ 3379] 40% to 50%, most preferably 43% to 48% inclusive of the water in the silicate solution
Water 6% to 45% by mass of the combined mass of phenolic resin and silicate solution.

The aluminium phosphate nano particle dispersion component is optionally provided up to 90% of aluminium phosphate by mass of the sodium silicate as a synergistic inorganic co-binder. This component act as a binder and as a refractory nano particle addition to other processed wood products such as wood board products, wood composites, veneers, plywoods, fibre boards wood frames and structural components, particularly in buildings, for enhancement of resistance to fire. A further major application is in wood impregnation and as a binder in the manufacture of wood-based composites, to enhance not only fire rating, but as a binder. Temperature tolerance of the binder itself is specified at 1600° C. or greater. In the case of applications in the timber or wood products industry the benefits are nano particle size, high temperature resistance and binding properties.

Aluminium tri hydrate AL (OH)₃ as a dispersion in water to form a slurry at a temperature between 60° C. and 95° C., may be used, the dispersed solid particles having a diameter of 1 micron or lower. In this further step there follows an acid to base reaction as ortho phosphoric acid, H₃PO₄ is added dropwise to the slurry. The aluminium hydroxyls react with acidic phosphonium to form ALPO₄ and water. The phosphate to aluminium ratio is important and is best at 3 to 1 or in the range 3 to 1.3 to 3 to 1.4. As the phosphoric acid increases so does phosphorous oxygen tetrahedron and polymerization, with rising viscosity and decreasing binder strength. Reaction temperature is best at 86° C. Three forms of aluminium phosphate result 3H₃PO₄+AI (OH)≥Al(H₂PO₄)₃+3H₂O or 3H₃PO₄+2AL(OH)₃≥Al₂ (HPO₄)₃+6H₂O or H₃PO₄+AL(OH)₃>AlPO₄+3H₂O. The aluminium phosphate AlPO₄ is amorphous, non-crystalline, nano particle sized and PH neutral, with a melt temperature of 1800° C. The surface area of the solids is approx. 20 sq m2 per gram. The reaction is a condensation reaction. Water may be added in the process to have between 10% to 40% Al(OH)₃ in the total mix.

Boric acid, B₃BO₃, controls the setting time as a reaction retarder.

Magnesium oxide, MgO, acts as a catalyst to speed the reaction if required.

The aluminium phosphate, in preference Al(H₂PO₄)₃,to AlPO₄, as nano particles in dispersion from a reaction of phosphoric acid with aluminium tri hydrate, in the proportion of 3 parts of phosphoric acid to 1 part by weight of aluminium trihydrate to form the condensate product, which has, as a binder, excellent adhesion, water insolubility, heat resistance, stable dispersion, and the nano particles can penetrate porous substrates such as wood products in particular, they may be added to wood or wood products as a binder or surface encapsulant, or as an impregnated compound into wood using vacuum/pressure technique.

In applications to processed wood products the liquid composition can be used much as would be the case in the use of organic adhesives during the manufacture of processed wood products. However, the more compelling use is in the vacuum/pressure impregnation of wood or processed wood products and in the case of plywoods, as an inter-veneer adhesive and as a prevention of structural failure in fire. The compound has a melt temperature of 1600° C. and a slurry density of 2.56 g/cc. This has particular application to multi-ply composites as a refractory surface coating, preferably with a high temperature fibrous or cellular reinforcing.

Aluminium phosphate may be impregnated on its own or in combination with alkali silicates, in accordance with the invention, in various proportions from 50% of each by mass, in water. Alternatively, the aluminium phosphate may be combined with the phenol formaldehyde in less than 50% of the phosphate resin by mass. In certain preferred circumstances, all three can be impregnated in a single mix with water.

Optionally, there is provided compounds to impose latency or an unchanged form of the resin to allow for prolonged storage of the composition in appropriate tanks. These can be selected from low carbon alcohols, methanol or ethanol, preferably methanol.

Water may be added to control the liquid rheology for, preferably in combination with the required mass of methanol to ensure resin latency, when included.

Regarding the component which includes boron, there is provided a boron preservation compound for wood, effective both as an insecticide and biocide, provided compatible with the binder system. A di-sodium octaborate tetrahydrate is preferred, at a concentration in the impregnation solution such as to achieve a dry percentage in the wood of 5 to 6.5 kgs of boric acid equivalent of the boron compound per cubic meter of wood, which equates to 15.5 grams per litre of the impregnation composition for an uptake of 70% by dry mass of wood. The uptake of the impregnation solution depends on the physics employed, such as level and duration of vacuum, followed by the subsequent pressure, and the concentration of modifying chemicals in the solution, but for a given set of such parameters, the wood species, its dryness, its age, its thickness and cross section dictate the uptake of the impregnation composition. Once this is averaged the make-up of the impregnated composition can be specified. For example, if the uptake average mass is 115% by mass of the wood, the impregnation composition must be adjusted to contain 10 grams of boric acid equivalent per litre. This is on the basis that the disodium octaborate tetrahydrate has a boric acid equivalent of 940 grams per kg.

A typical composition would be 15% sodium silicate, boric acid equivalent 6 kgs per m3 ie 10 to 16 grams disodium octaborate tetra hydrate per litre, and the balance being water.

The invention also extends to a method of impregnation of wood products, preferably processed wood products using the described lignocellulosic binder system. The method includes the steps of:
preparing a lignocellulosic binder system as an impregnation mixture as described above;
applying a vacuum to processed wood products in a chamber;
introducing the impregnation mixture into the vacuum chamber in surface contact with the processed wood products; and
applying pressure to the chamber.

The method of impregnation of wood products, may include the further step of laying the resinated furnish on a moving belt of a press; and
pressing the laden furnish while applying heat.

Double belt pressing is preferred, at a temperature of about 90° C., at pressures required to reduce the thickness of the untreated processed wood product by between 10 and 40%, preferably about 25% reduction in thickness.

The method does not require a carbon dioxide application step.

The impregnated wood products may be kiln dried, stacked and spaced onto a trolley on rails. The trolley is pushed into an impregnation chamber. The chamber is fitted with an inlet, outlet and drainage pipes with stop cocks. In addition, there are vacuum lines and air pressure lines leading to the vacuum pump and air compressor respectively. The chamber is closed by a domed multi bolted door. A vacuum is drawn, with the various other valves being closed to a consistent negative pressure of 70 kPa and held until the pressure is constant, usually about 20 minutes. The vacuum line is now closed, and the cylinder is flooded with the impregnation mixture liquid usually from a holding tank mounted on top of and in fluid communication with the vacuum cylinder so that cascade filling is very rapid to ensure that the negative pressure in the wood is not depleted before the mixture contacts the wood. Valves are opened and closed as required rapidly. The air pressure line is now opened subjecting the charge to immediate positive air pressure from a ballast tank and the pressure is maintained by the compressor at up to 10 bar more usually 6 bar i.e. 1000 down to 600 KPA. This cycle is held for 20 to 30 minutes, the air pressure is then partly released, after which the liquid is returned to its holding tank by subjecting the chamber to a positive compressed air pressure after the outlet pipe has been opened until all the liquid is removed.

Products manufactured in large quantity from chips, fibers, veneers, strands, paper and pulp are all in need of modification in order to be suitable for applications that require resistance to fire, and to attack by insects or micro organisms, and to water absorption, that are much stronger and resistant to impact, that are rigid and resist deformation or thickness swelling in water, and which are hard and durable to abrasion but which can easily be sawn, drilled, machined and coated.

These products include particle board, medium and high density fiber board, orientated strand board, veneers, paper composites such as single or multi layer corrugated boards, spirally wound paper tubing, cellular assemblies of paper vertically orientated such as Dufaylite, and multi laminates of paper boarding often referred to, in the paper industry, as chipboard, weighing in the range 400 to 900 grams per square meter per sheet.

The balance between phenolic resin percentage in the impregnation composition and the sodium silicate percentage that gives the best cost to property ratio is in the range;
Phenolic resole resin 48% to 56%, most preferably 52% to 55%
Alkali silicate [PQ 3379] 40% to 50%, most preferably 43% to 48% inclusive of the water in the silicate solution
Water 6% to 45% by mass of the combined mass of phenolic resin and silicate solution.

The colour imparted by the phenolic resin when polymerization has completed, is not particularly important in the case of impregnated wood derivatives. Water percentage to optimize mix viscosity can determine final mass or density, but alkali silicate is the main contributor to final density.

The silicate has a major influence on resistance to fire, the phenolic is the main binder but the combination of both optimizes final desirable properties of the wood derivatives in all cases.

The impregnation of pre-manufactured board products allows for the imposition of desirable properties needed for their use in the built environment, which cannot be achieved during board manufacture itself.

Processed wood products include particle board, soft board, medium and high-density fibre board, hardboard, plywood, orientated strand board and laminated veneer lumber. The products manufactured from fibres, chips or particles are usually bound by any of urea formaldehyde, phenol formaldehyde, or water dispersible isocyanates. Process temperatures in the presses used are in the range 180 to 220° C. for between 4 and 26 seconds per millimetre thickness at pressures of up to 50 kgs/cmsq. Water in the binder converts to super-heated steam which rapidly penetrates to the board core accelerating resin polymerisation.

The invention also extends to a method of manufacture of processed wood products using the described lignocellulosic binder system, with the boron component being optional unless for exterior use. The method includes the steps of:
preparing a lignocellulosic binder system as an impregnation mixture as described above;
applying the mixture to the wood particle or fibres (furnish) to produce resinated furnish;
laying the resinated furnish on a moving belt of a press; and
pressing the laden furnish while applying heat.

The equipment for binder system storage, application to the furnish, mechanisation of weighing, spreading, pressing, drying and handling are as provided in most existing board plants. Double belt pressing is preferred, at a temperature of about 90° C., at pressures required up to 50 kgs per cm^{2.}

The water percentage above that is typical of alkali silicates as supplied, is not usually required.

The processed wood products have increased strength, water resistance, fire resistance and resistant to bio degradation, making it useful for new or outside uses such as wall cladding, shingles, roof tiles, floor planks, and other building uses as well as material handling such as pallets.

The invention also extends to a method of manufacture of paper or paper composite products using the described lignocellulosic binder system, with the boron component being optional unless for exterior use. The method includes the steps of:
preparing a lignocellulosic binder system as an impregnation mixture as described above; and
impregnating paper products with the impregnation mixture.

Paper products in single layer sheet form are impregnated typically in a reel to drier to reel format, followed by multi-layer lamination with heat, which causes the polymerisation of the phenolic as the temperature exceeds 110° C.

Paper composites, such as corrugated cardboard in sheet form, are impregnated by immersion in the impregnating liquid while placed on perforated metal flat sheet holding trays which are then sequentially removed from the liquid composition and tilted to allow drainage of the excess liquid.

Paper sheets are conventional thin sections of from 100 grams per m2 to those referred to as chip, at up to single thickness weights of 700 grams per m2.

These paper sheets lend themselves to multi laminations in a press to produce very strong boards or single laminations for laminating to other board products.

Corrugated cardboard has liners of 200 to 340 grams per m2 and fluting of 150 to 250 grams per m2, and may be single liner/flute/liner lay up or multiples of these up to 100 mm thick or more. Thicknesses of single layers of corrugated cardboard are available from manufacturers ranging from 2 mm to 12 mm, which provide for multiple applications in construction, materials handling, and other industries.

Paper of processed wood products requires drying at a temperature of about 80° C. Resin mass introduced to paper is of the order 15% and into wood boards, 15% or more.

The invention also extends to products impregnated with or bound with the described lignocellulosic binder system.

Sodium silicate solution is mixed with phenolic resin in proportions of between 10% and 60%. The silicate provides a lower curing temperature, higher thermal stability, an increase in crosslink density, a lower curing temperature, increased hardness, increased bond strength, lowered temperature of polymerization, less smoke, and improved flame retardance. It also lowers brittleness and promotes hydrogen bonds and some chemical bond, such as cross linking to lignin. The post impregnation cure temperature is 90 to 120° C.

The most rapid silicate gelation is at a pH in the range 5 to 8. Time delayed gelation is at a Ph in the range 8 to 10 The silicate forms a silica hydro gel. The silicate reacts with polyvalent cations, such as calcium chloride, which is a hygroscopic deliquesant, which also acts as a suspending agent, and added as a micro-particle. The building block in polymerization is mono silicic acid Si(OH)₄ leading to a phenol silicate Na₂Si03 PF. The silicate confers several desirable properties to the resin. The setting or gelation of the silicate solution is by reaction with acid forming salts, such as those of calcium, or magnesium or aluminium or by acids themselves, such as boric, carbonic, oxalic, copper, lead and sulphurous. The phenolic resole resin has approximately 37% of formaldehyde and a polymerizing temperature of 80° C. The phenol formaldehydes are noted for hardness, excellent binding with added advantage of low smoke emission, flame retardance, high temperature resistance, and imposing proofness to insect or microbial attack.

It is further desirable to include a surfactant such as a polycarboxylate added at 1 to 10% of the non-ionic surfactant. Below a pH of 10 the silicate solution begins to form a silica gel. Glycerol diacetate also promotes Si—O—Si bonds from ester curing. The composition forms a phenyl silicate Na₂SiO₃PF.

The aluminium phosphate contributes binding and temperature resistance synergistically with the silicate.

IMPREGNATION OF PROCESSED WOOD PRODUCTS

| WOOD | CHIPBOARD | MDF | OSB | PLYWOOD |
|---|---|---|---|---|
| MASS | 294 | 346 | 209 | 317 |
| WET MASS | 652 | 851 | 469 | 707 |
| UPTAKE | 358 | 505 | 260 | 390 |
| PRESSED MASS | 450 | 566 | 293 | 420 |
| DRY MASS | 398 | 398 | 319 | 476 |
| THICKNESS | 14 | 16 | 12 | 18 |
| WET THICKNESS | 20 | 23 | 15 | 19 |
| PRESSED | 11 | 14 | 11 | 16 |
| THICKNES | | | | |
| DENSITY | 0.69 | 0.73 | 0.55 | 0.60 |
| WET DENSITY | 1.06 | 1.2 | 1.04 | 1.20 |
| DRY DENSITY | 1.2 | 1.3 | 0.97 | 0.98 |

### 1. Basic Lignocellulosic Binder System Comprising:

PHENOLIC RESOLE 28%
SODIUM SILICATE SOLUTION IN WATER PQ CORP CODE 3379 25%
WATER 47%

### 2. Basic Lignocellulosic Binder System Comprising:

PHENOLIC RESOLE 50%
SODIUM SILICATE SOLUTION IN WATER PQ CORP CODE 3379 42%
WATER 8%

The procedure in the case of wood impregnation, is firstly to prepare the sawn wood to desirable dimension making allowance for post treatment sanding or machining or slight swelling. Machining such as planing before impregnation is not desirable since the surface cellular compression can inhibit impregnation penetration. The kiln dried, wood is stacked in the treatment cylinder, the boards spaced from each other by stickers or thin sawn sections, the thickness of which is 10 mm to 20 mm, and the boards approximately 20 mm apart from each other, allowing for the flow of the composition to envelope each board in every direction. The cylinder has domed end and door, providing for air-tight sealing. Vacuum is drawn, preferably by two stage vacuum pumps, with a ballast cylinder to minimize loss of negative pressure during cylinder filling with the treatment liquid. The vacuum drawn is down to 70 kPa to evacuate all air and most water vapour possible, by being held for approximately 20 minutes. The treatment composition is preferably held in a cylinder mounted on top of the impregnation cylinder. When the vacuum lines are sealed, the liquid holding cylinder pipe, linking to the bottom cylinder, is opened and the impregnation cylinder is filled rapidly and fully. Pressure is now applied to the impregnation cylinder by compressed air to 600 to 950 KPA for approximately 25 minutes. The treatment liquid is returned to the upper cylinder by compressed air, the impregnation cylinder door is opened, and the charge which has been stacked on a flat-bottomed rail truck, is withdrawn and after full drainage, is rolled into the kiln for heat treatment at up to 180° C. by gradual timed stages. The vaporization of methanol during the process of drying is a potential hazard and capture by passing through water or other capture techniques is important. Finally, the dried wood is dressed and coated depending on use application. Both the silicate and the phenolic resin provide a high degree of protection against insect and micro-organism attack as well as a considerable protection against fire including flame retardance, low smoke emission, high temperature resistance. The phenol in the resin imparts to impregnated wood a pleasing red/brown colour, quite typical of many hardwoods.

The colour imparted by the phenolic resin when polymerization has completed, is not particularly important in the case of impregnated wood derivatives. Water percentage to optimize mix viscosity can determine final mass or density, but alkali silicate is the main contributor to final density.

It shall be understood that the mass percentage of each component is variable within the limits described and the binder can be adapted from various purposes and the examples are provided for illustrating the invention further and to assist a person skilled in the art with understanding the invention and are not meant to be construed as unduly limiting the reasonable scope of the invention.

1. A lignocellulosic binder system, which binder system comprises:
an aqueous alkali metal silicate solution; and
a liquid phenol formaldehyde; and
aluminium phosphate nano particle dispersion.

2. (canceled)

3. A lignocellulosic binder system as claimed in claim 1, which comprises a component which comprises boron.

4. A lignocellulosic binder system as claimed in claim 1 wherein the alkali metal silicate is selected from sodium silicate solution in water and/or potassium silicate solution in water.

5. A lignocellulosic binder system as claimed in claim 4, wherein the silica to sodium ratio is in the range in the range 0.5 to 4.1 to 1 and 20% to 60% by mass of the composition of the system.

6. A lignocellulosic binder system as claimed in claim 4, wherein the silica to potassium ratio is 2.55 to 1 to 1.45 to 1 in the 20% to 60% range by mass of the composition of the system.

7. A lignocellulosic binder system as claimed in claim 4, which comprises a blend of sodium and potassium silicate in proportion of 3 parts sodium silicate to 1 part potassium silicate.

8. A lignocellulosic binder system as claimed in claim 1, wherein the liquid phenol formaldehyde component is in the form of a resole resin at up to 15% to 90%.

9. A lignocellulosic binder system as claimed in claim 1, which comprises a catalyst at between 10% to 20% by mass selected from glycerol di and/or tri acetate or propylene carbonate or latent temperature activated catalyst.

10. A lignocellulosic binder system as claimed in claim 1, which comprises water 6% to 45% by mass of the combined mass of the components of the system.

11. A lignocellulosic binder system as claimed in claim 1, which comprises an aluminium phosphate nano particle dispersion component.

12. A lignocellulosic binder system as claimed in claim 1, which comprises Aluminium tri hydrate AL (OH)₃ which was dispersed in water to form a slurry at a temperature between 60° C. and 95° C., the dispersed solid particles having a diameter of 1 micron or lower and H₃PO₄ is added dropwise to the slurry to form aluminium phosphate.

13. A lignocellulosic binder system as claimed in claim 1, which comprises Boric acid.

14. A lignocellulosic binder system as claimed in claim 1, which comprises magnesium oxide.

15. A lignocellulosic binder system as claimed in claim 12, wherein the aluminium phosphate, as nano particles in dispersion are in the proportion of 3 parts of phosphoric acid to 1 part by weight of aluminium trihydrate.

16. A lignocellulosic binder system as claimed in claim 1, which comprises compounds to impose latency selected from low carbon alcohols.

17. A lignocellulosic binder system as claimed in claim 3, wherein the boron containing component is selected from di-sodium octaborate tetrahydrate.

18. A method of impregnation of wood products, which method comprises the steps of:
preparing a lignocellulosic binder system as an impregnation mixture as claimed in claim 1;
applying a vacuum to processed wood products in a chamber;
introducing the impregnation mixture into the vacuum chamber in surface contact with the processed wood products; and
applying pressure to the chamber.

19. A method of impregnation of wood products as claimed in claim 18, wherein the wood products are selected from processed wood products.

20. A method of impregnation of wood products as claimed in claim 19, which method comprises the further step of laying the resinated furnish on a moving or stationary belt of a press; and
pressing the laden furnish while applying heat.

21. A method of impregnation of wood products as claimed in claim 20, which method comprises the step of kiln drying.

22. A method of manufacture of processed wood products, which method comprises the steps of:
preparing a lignocellulosic binder system as an impregnation mixture as claimed in claim 1;
applying the mixture to the wood particle or fibres (furnish) to produce resinated furnish;
laying the resinated furnish on a moving belt of a press; and
pressing the laden furnish while applying heat.

23. A method of manufacture of paper or paper composite products, which method comprises the steps of:
preparing a lignocellulosic binder system as an impregnation mixture as claimed in claim 1; and
impregnating paper or paper composite products.

24. A product impregnated with or bound with a lignocellulosic binder system as claimed in any one of claims 1 to 17.

25-29. (canceled)
